(19) United States
(12) Patent Application Publication
(10) Pub. No.: US 2026/0189164 A1
(43) Pub. Date: Jul. 2, 2026

(54) MOTOR DRIVING APPARATUS AND METHOD FOR CONTROLLING THE SAME

(71) Applicants: HYUNDAI MOTOR COMPANY, SEOUL (KR); KIA CORPORATION, SEOUL (KR)

(72) Inventors: Sang Woo Park, Hwaseong-si (KR); Ho Rim Choi, Hwaseong-si (KR); Tae Jun Moon, Hwaseong-si (KR); Tae Il Yoo, Hwaseong-si (KR); Jin Wook Kang, Hwaseong-si (KR)

(73) Assignees: HYUNDAI MOTOR COMPANY, SEOUL (KR); KIA CORPORATION, SEOUL (KR)

(21) Appl. No.: 19/325,127

(22) Filed: Sep. 10, 2025

(30) Foreign Application Priority Data
Jan. 2, 2025 (KR) 10-2025-0000538

(51) Int. Cl. H02P 21/14

(52) U.S. Cl. CPC H02P 21/14

(57) ABSTRACT

A motor driving apparatus and method for controlling the same are provided, in order to improve torque control precision of an induction motor driven by an indirect vector control method. The motor driving apparatus includes an induction motor having a stator, and a rotor that rotates through a rotating magnetic field generated in the stator, as well as a controller for determining resistance of the rotor on the basis of an error between a reference torque and an output torque of the induction motor as well as a temperature of the induction motor and for controlling an output of the induction motor on the basis of the determined resistance of the rotor.

### CROSS REFERENCE TO RELATED APPLICATIONS

The present application claims priority to Korean Patent Application No. 10-2025-0000538, filed on Jan. 2, 2025, the entire contents of which are incorporated herein for all purposes by this reference.

### BACKGROUND

### Technical Field

The present disclosure relates to a motor driving apparatus and method for controlling the same in order to improve torque control precision of an induction motor driven by an indirect vector control method.

### Description of the Related Art

The induction motor, which generates rotational force through the electromagnetic force of induced current generated in the rotor by the rotating magnetic field of the stator, can instantaneously control torque by controlling the magnetic flux component current and torque component current through a synchronous reference frame that rotates at the rotational speed of the magnetic flux vector.

The technique for instantaneous torque control of such induction motors can be referred to as a vector control, and the vector control may be divided into direct vector control and indirect vector control according to a method of obtaining a magnetic flux angle. Of the two, direct vector control is a method of directly obtaining the magnetic flux angle by estimating the magnetic flux itself, and indirect vector control is a method of indirectly obtaining the magnetic flux angle by obtaining slip angular velocity.

Unlike the direct vector control method, the indirect vector control method controls the torque of the motor by indirectly estimating the magnetic flux angle through slip angular velocity, so accurately determining the slip angular velocity becomes an important factor in improving the precision of torque control.

Herein, the slip angular velocity is generated as the rotor in the induction motor always rotates slowly compared to the synchronous speed of the rotating magnetic field, and can be obtained on the basis of the ratio of rotor resistance to rotor inductance and the current reference on the synchronous reference frame.

The matters described as background technology above are only intended to enhance understanding of the background of the present disclosure, and should not be taken as acknowledging that it corresponds to the prior art already known to those skilled in the art.

### SUMMARY

Various aspects of the present disclosure is to provide a motor driving apparatus and a method for controlling the same, which is capable of improving torque control precision of an induction motor by estimating a value of a rotor resistance which varies in real time and performing an indirect vector control.

A motor driving apparatus according to various aspects of the present disclosure includes an induction motor having a stator and a rotor that rotates through a rotating magnetic field generated in the stator, and a controller for determining a resistance of the rotor on the basis of an error between a reference torque and an output torque of the induction motor as well as a temperature of the induction motor, and for controlling an output of the induction motor on the basis of the determined resistance of the rotor.

For example, the controller may perform torque error control to allow the output torque to track the reference torque on the basis of the temperature of the induction motor, and may determine the resistance of the rotor on the basis of a result of the torque error control.

For example, the controller may repeatedly perform the torque error control until the error between the reference torque and the output torque becomes less than or equal to a predetermined reference error, and may re-determine the resistance of the rotor.

For example, the controller may perform the torque error control on the basis of a control gain predetermined to correspond to the temperature of the induction motor and the reference torque.

For example, the control gain may include proportional gain and integral gain with respect to the error between the reference torque and the output torque.

For example, the controller may perform the torque error control by referring to a table which stores the control gain corresponding to each of the temperature of the induction motor and the reference torque.

For example, the controller may correct a result of the torque error control through an anti-windup with respect to the error between the reference torque and the output torque, and may determine the resistance of the rotor on the basis of the corrected result of the torque error control.

For example, the temperature of the induction motor may be a coil temperature of the stator.

For example, the controller may determine slip angular velocity of the induction motor on the basis of the resistance of the rotor and may control the output of the induction motor on the basis of the determined slip angular velocity.

For example, an inverter for driving the induction motor may be further included, wherein the controller may convert a current of the stator into a synchronous reference frame on the basis of the slip angular velocity and may control the output of the induction motor by controlling the inverter through pulse width modulation (PWM) control based on the converted current.

A method for controlling a motor driving apparatus according to an exemplary embodiment of the present disclosure for achieving the task described above includes determining a resistance of a rotor by a controller on the basis of an error between a reference torque and an output torque of an induction motor composed of a stator and the rotor that rotates through a rotating magnetic field generated in the stator as well as a temperature of the induction motor, and controlling an output of the induction motor by the controller on the basis of the determined resistance of the rotor.

For example, the determining the resistance of the rotor may include performing torque error control to allow the output torque to track the reference torque on the basis of the temperature of the induction motor by the controller, and determining the resistance of the rotor on the basis of a result of the torque error control.

For example, the determining the resistance of the rotor may include performing repeatedly the torque error control by the controller until the error between the reference torque and the output torque becomes less than or equal to a predetermined reference error to re-determine the resistance of the rotor.

For example, the determining the resistance of the rotor may include performing the torque error control by the controller on the basis of a control gain predetermined to correspond to the temperature of the induction motor and the reference torque.

For example, the control gain may include proportional gain and integral gain with respect to the error between the reference torque and the output torque.

For example, the determining the resistance of the rotor may include performing the torque error control by the controller by referring to a table which stores the control gain corresponding to each of the temperature of the induction motor and the reference torque.

For example, the determining the resistance of the rotor may include correcting a result of the torque error control by the controller through an anti-windup with respect to the error between the reference torque and the output torque, and determining the resistance of the rotor on the basis of the corrected result of the torque error control.

For example, the temperature of the induction motor may be a coil temperature of the stator.

For example, the controlling the output of the induction motor may include determining slip angular velocity of the induction motor by the controller on the basis of the resistance of the rotor, and controlling the output of the induction motor on the basis of the determined slip angular velocity.

For example, the controlling the output of the induction motor may include converting a current of the stator into a synchronous reference frame by the controller on the basis of the slip angular velocity, and controlling the output of the induction motor by controlling an inverter for driving the induction motor through pulse width modulation control based on the converted current.

According to various exemplary embodiments of the present disclosure as described above, the estimation accuracy of the magnetic flux angle may be improved during indirect vector control, and accordingly, the precision of torque control may be improved, by determining the slip angular velocity through the value of the rotor resistance that varies in real time.

In addition, as the precision of torque control improves, reference torque tracking performance can be improved without a separate torque correction process.

Furthermore, various exemplary embodiments of the present disclosure may be implemented by adding logic to an existing controller, thereby achieving the effects described above without any increase in volume and cost due to a separate hardware configuration.

The effects obtained by the present disclosure are not limited to the effects mentioned above, and other effects not mentioned may be clearly understood by those skilled in the art to which the present disclosure pertains from the following description.

### BRIEF DESCRIPTION OF THE FIGURES

FIG. 1 is a view showing a configuration of a motor driving apparatus according to an exemplary embodiment of the present disclosure.

FIG. 2 is a view showing an example of an implementation of a motor driving apparatus according to an exemplary embodiment of the present disclosure.

FIG. 3 is a view illustrating a method of determining rotor resistance according to an exemplary embodiment of the present disclosure.

FIG. 4 is a flowchart illustrating a method of controlling a motor driving apparatus according to an exemplary embodiment of the present disclosure.

### DETAILED DESCRIPTION

Specific structural or functional descriptions with respect to exemplary embodiments of the present disclosure are illustrated only for the purpose of explaining the exemplary embodiments according to the present disclosure, and the exemplary embodiments according to the present disclosure may be implemented in various forms and should not be construed as being limited to the exemplary embodiments described in the present specification or application.

An exemplary embodiment according to the present disclosure may be subject to various modifications and can take many forms, so specific exemplary embodiments are illustrated in the drawings and will be described in detail in the present specification. However, this is not intended to limit exemplary embodiments in accordance with the concepts of the present disclosure to any particular disclosed form, and should be understood to include all modifications, equivalents, or substitutes that fall within the scope of the ideas and techniques of the present disclosure.

Unless otherwise defined, all terms used herein, including technical or scientific terms, have the same meaning as those generally understood by those skilled in the art to which the present disclosure pertains. Terms such as those defined in a generally used dictionary should be interpreted as having a meaning consistent with the meaning of the context of the relevant technology and should not be interpreted in an idealized or overly formal sense unless expressly defined herein.

Hereinafter, exemplary embodiments disclosed in the present specification will be described in detail with reference to the accompanying drawings, but identical or similar components will be given the same reference numerals regardless of the drawing symbols, and redundant descriptions thereof will be omitted.

In the description of the following exemplary embodiments, the term “predetermined” means that a numerical value of a parameter is determined in advance when the parameter is used in a process or algorithm. According to an exemplary embodiment, the numerical value of the parameter may be set when the process or algorithm starts or may be set during a section where the process or algorithm is performed.

The suffixes “module” and “unit” for components used in the following description are assigned or used interchangeably only for taking the convenience of writing the specification into consideration and are not intended to have a distinct meaning or role in and of themselves.

In describing exemplary embodiments disclosed in the present specification, the detailed description thereof will be omitted when it is determined that a detailed description of the related known technology may obscure the gist of the exemplary embodiments disclosed in the present specification. In addition, the attached drawings are only intended to facilitate an easy understanding of the exemplary embodiments disclosed in the present specification, and the technical ideas disclosed in the present specification are not limited by the attached drawings, and should be understood to include all modifications, equivalents, and substitutes included in the idea and technical scope of the present disclosure.

Terms including ordinal numbers, such as first and second, may be used to describe various components, but the components are not limited by the terms. The terms are used only for the purpose of distinguishing one component from another component.

When it is mentioned that a component is “connected” or “linked” to another component, it should be understood that it may be directly connected or linked to that other component, but there may be other components in between. Meanwhile, when it is mentioned that a component is “directly connected” or “directly linked” to another component, it should be understood that there are no other components in between.

Singular expressions may include plural expressions unless the context clearly indicates otherwise.

In the present specification, terms such as “include” or “have” may be intended to specify the existence of features, numbers, steps, operations, components, parts, or combinations thereof described in the specification, and should be understood not to preclude the existence or addition of one or more other features, numbers, steps, operations, components, parts, or combinations thereof.

In addition, a unit or control unit included in names such as a motor control unit (MCU) and a hybrid control unit (HCU) may be only terms widely used to name a controller that controls vehicle-specific functions, and may not mean a generic function unit.

The controller may include a communication device for communicating with other controllers or sensors to control the functions it is responsible for, a memory for storing operating systems or logic commands and input/output information, and one or more processors for performing determination, calculation, decision and the like necessary to control the functions it is responsible for.

The motor driving apparatus and the method for controlling the same according to an exemplary embodiment of the present disclosure may determine the rotor resistance on the basis of the temperature of the induction motor, and may perform indirect vector control through the slip angular velocity derived therefrom, thereby improving the precision of torque control.

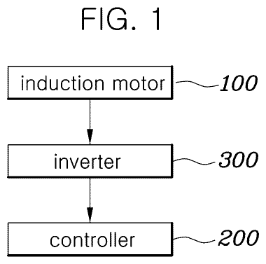

Hereinafter, a configuration of a motor driving apparatus will be described first with reference to FIG. 1 before describing a method for controlling the motor driving apparatus according to an exemplary embodiment of the present disclosure.

FIG. 1 is a simplified block diagram showing a configuration of a motor driving apparatus according to an exemplary embodiment of the present disclosure.

Referring to FIG. 1, a motor driving apparatus according to an exemplary embodiment of the present disclosure may include an induction motor 100, a controller 200, and an inverter 300. The motor driving apparatus may be implemented by including more or fewer components than those shown in FIG. 1.

The induction motor 100 may have a stator and a rotor that rotates through a rotating magnetic field generated in the stator. The stator may include a coil for generating the rotating magnetic field, and the rotor may rotate by an electromagnetic force of an induced current by the rotating magnetic field.

The controller 200 may control the output of the induction motor 100 and, in particular, the controller 200 may determine the resistance of the rotor on the basis of the error between the reference torque and the output torque of the induction motor 100 and the temperature of the induction motor 100. In addition, the controller 200 may determine the slip angular velocity of the induction motor 100 on the basis of the determined resistance of the rotor and may control the output of the motor 100 on the basis of the determined slip angular velocity.

The inverter 300 may drive the induction motor 100 and, for example, may drive the induction motor 100 through a switching operation of a switching element such as an insulated gate bipolar transistor (IGBT) and a metal oxide semiconductor field effect transistor (MOSFET). Such a switching operation may be controlled by the controller 200, and the controller 200 may control the output of the induction motor 100 by controlling the inverter 300 on the basis of the reference torque.

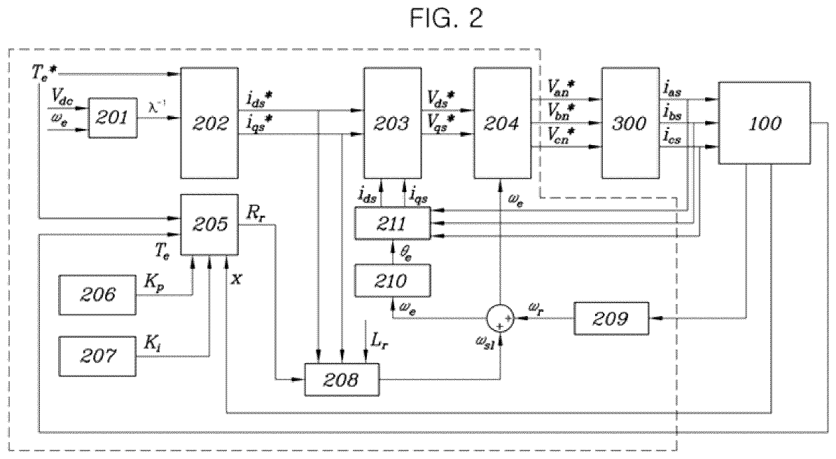

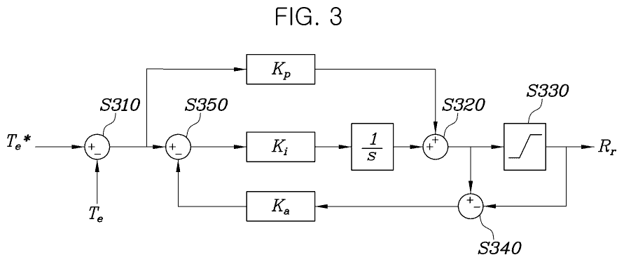

Specific details regarding the motor driving apparatus according to an exemplary embodiment of the present disclosure will be described in more detail below with reference to FIGS. 2 and 3.

FIG. 2 is a simplified block diagram showing an example of an implementation of a motor driving apparatus according to an exemplary embodiment of the present disclosure, and FIG. 3 is a flow diagram illustrating a method of determining rotor resistance according to an exemplary embodiment of the present disclosure.

First, referring to FIG. 2, the induction motor 100 according to an exemplary embodiment of the present disclosure may be implemented as a three-phase alternating current motor, and the inverter 300 may be implemented as a pulse width modulation (PWM) inverter. In addition, the controller 200 may include a magnetic flux controller 201, a current reference map 202, a current controller 203, a first converter 204, a torque error controller 205, a first gain table 206, a second gain angle table 207, a slip angular velocity determination unit 208, a rotation angular velocity determination unit 209, a magnetic flux angle determination unit 210, and a second converter 211.

The magnetic flux controller 201 may receive a direct current voltage (V_{dc}) inputted to the inverter 300 and a synchronous speed (ωₑ) of the rotating magnetic field as inputs, and may output an inverse magnetic flux (λ⁻¹). The current reference map 202 may receive the outputted inverse magnetic flux (λ⁻¹) and a reference torque (Tₑ*) as inputs, and may output the corresponding d-axis current reference (i_{ds}*) and q-axis current reference (i_{qs}*). For example, the reference torque (Tₑ*) may be directly inputted to the controller 200 according to an exemplary embodiment or may be obtained from a connected upper controller.

The current controller 203 may output a d-axis voltage reference (V_{ds}*) and a q-axis voltage reference (V_{qs}*) of the synchronous reference frame according to the d-axis current reference (i_{ds}*) and the q-axis current reference (i_{qs}*) of the synchronous reference frame. The outputted d-axis voltage reference (V_{ds}*) and the q-axis voltage reference (V_{qs}*) may be converted into a three-phase voltage reference (Vₐₙ*, V_{bn}*, V_{cn}*) through the first converter 204 and then may be inputted to the inverter 300.

The inverter 300 may output a voltage according to the three-phase voltage reference (Vₐₙ*, V_{bn}*, V_{cn}*), such that three-phase currents (iₐₛ, i_{bs}, i_{cs}) flow in the stator of the induction motor 100 to generate the rotating magnetic field. For example, the rotor of the induction motor 100 may rotate by an electromagnetic force caused by the induced current of the rotating magnetic field, thereby generating torque (Tₑ).

Meanwhile, the controller 200 according to an exemplary embodiment of the present disclosure may include a torque error controller 205 for performing a torque error control, and the torque error controller 205 may determine the rotor resistance (Rᵣ) of the induction motor 100 on the basis of the error between the reference torque (Tₑ*) and the output torque (Tₑ) of the induction motor 100 and the temperature (x) of the induction motor 100.

More specifically, the torque error controller 205 may perform the torque error control so that the output torque (Tₑ) of the induction motor 100 can track the reference torque (Tₑ*) on the basis of the temperature (x) of the induction motor 100, and may determine the resistance (Rᵣ) of the rotor on the basis of the result of the torque error control.

To this end, the torque error controller 205 may have the reference torque (Tₑ*), the output torque (Tₑ), and the temperature (x) of the induction motor 100 as an input value, and may have the resistance (Rᵣ) of the rotor as an output value.

Herein, the reference torque (Tₑ*) may be directly input to the torque error controller 205 or may be transmitted from an upper controller, and the output torque (Tₑ) may be the measured torque which the induction motor 100 outputs, and may be measured through a sensor inside or outside the induction motor 100 to be input to the torque error controller 205.

Meanwhile, the temperature (x) of the induction motor 100 may refer to, for example, the temperature of the stator coil of the induction motor 100, and may be measured through a temperature sensor connected to the stator coil to be transmitted to the torque error controller 205. However, the temperature (x) of the induction motor 100 may not necessarily be limited to the temperature of the stator coil, and may include a temperature of an arbitrary position outside or inside the induction motor 100, a temperature of a rotor, and the like, and may be obtained by various temperature determination/estimation methods in addition to being measured and obtained through a temperature sensor.

The torque error controller 205 may perform the torque error control through feedback control to allow the output torque (Tₑ) to track the reference torque (Tₑ*) on the basis of the input values, and the torque error control may be repeatedly performed until an error between the reference torque (Tₑ*) and the output torque (Tₑ) becomes less than or equal to a predetermined reference error (e.g., “0”). The resistance (Rᵣ) of the rotor may be determined in real time on the basis of a result of each torque error control, and may be re-determined and updated in real time as the torque error control is repeated.

Meanwhile, the torque error control may be performed, for example, through proportional-integral (PI) control, in which case the temperature (x) of the induction motor 100 can be utilized to determine the control gain.

More specifically, the control gain of the torque error control may be predetermined to correspond to the temperature (x) of the induction motor and the reference torque (Tₑ*) and may be obtained, for example, through tables 206, 207 which store the control gain corresponding to each of the temperature (x) of the induction motor and the reference torque (Tₑ*).

In addition, such control gains may include a proportional gain (K_{P}) and an integral gain (Kᵢ) of the reference torque (Tₑ*) and the output torque (Tₑ), and the proportional gain (KP) and the integral gain (Ki) may be obtained through respective gain tables 206, 207.

Meanwhile, the resistance (Rᵣ) of the rotor may be determined on the basis of the result of the torque error control, for which a relationship between the torque of the induction motor 100 and the rotor resistance (Rᵣ), such as a voltage-torque characteristic curve, may be utilized.

Hereinafter, an operation performed by the torque error controller 205 will be described in more detail with reference to FIG. 3.

Referring to FIG. 3, a control block diagram of the torque error controller 205 is illustrated, and a process of the torque error control performed by the torque error controller 205 is shown.

First, the torque error controller 205 may subtract the output torque (Tₑ) from the reference torque (Tₑ*) (S310) and may determine the error between the reference torque (Tₑ*) and the output torque (Tₑ).

Thereafter, the torque error controller 205 may perform proportional-integral control by adding up a value obtained by applying the proportional gain (Kₚ) to the error between the determined reference torque (Tₑ*) and the output torque (Tₑ) and a value obtained by applying the integral gain (Kᵢ) to and integrating the error between the reference torque (Tₑ*) and the output torque (Tₑ) (S320).

For example, a value outputted as a result of the proportional-integral control may be limited by a limit value for preventing accumulation of error integral values (S330). For example, the torque error controller 205 may prevent error divergence at the time of integration by applying an anti-windup gain (Kₐ) to the value obtained by subtracting the limit value from the value outputted as a result of the proportional-integral control (S340) and then by subtracting this from the error between the reference torque (Tₑ*) and the output torque (Tₑ) to perform the integral control (S350).

By determining the resistance (Rᵣ) of the rotor on the basis of the temperature of the induction motor 100 in this way, indirect vector control may be performed by reflecting the variation of the resistance (Rᵣ) of the rotor according to the temperature.

Meanwhile, referring back to FIG. 2 again, when the rotor resistance (Rᵣ) is determined in the torque error controller 205, the slip angular velocity determination unit 208 may determine the slip angular velocity (ωₛₗ) on the basis of the rotor resistance (Rᵣ) determined in the torque error controller 205, the d-axis current reference (i_{ds}*), the q-axis current reference (i_{qs}*) of the synchronous reference frame generated in the current reference map 202, and the rotor inductance (Lᵣ). For example, a value predetermined by, for example, a vehicle test, and the like may be utilized for the rotor inductance (Lᵣ).

More specifically, the slip angular velocity determination unit 208 may determine the slip angular velocity by utilizing the following equation.

$${ω}_{sl} = \frac{{R}_{r} {i}_{qs}^{*}}{{L}_{r} {i}_{ds}^{*}}$$

Herein, the slip angular velocity (ωₛₗ) may be determined on the basis of the rotor resistance (Rᵣ) determined by reflecting the temperature of the induction motor 100 in the torque error controller 205, so it can be determined relatively accurately by reflecting the value of the current rotor resistance (Rᵣ).

Meanwhile, the rotation angular velocity determination unit 209 may determine the rotation angular velocity (ωᵣ) of the rotor of the induction motor 100 on the basis of the sensing values and, for example, the rotation angular velocity (ωᵣ) of the rotor may be determined through the position of the rotor obtained through a position sensor such as a resolver.

The slip angular velocity (ωₛₗ) and the rotation angular velocity (ωᵣ) determined in the slip angular velocity determination unit 208 and the rotation angular velocity determination unit 209 may be added to be the synchronous angular velocity (ωₑ) of the rotating magnetic field, and the magnetic flux angle determination unit 210 may determine the magnetic flux angle (θₑ) by integrating the synchronous angular velocity (ωₑ). The magnetic flux angle (θₑ) determined in this way may be used to convert the three-phase stator currents (iₐₛ, i_{bs}, i_{cs}) of the induction motor 100 into the d-axis current (i_{ds}) and q-axis current (i_{qs}) of the synchronous reference frame in the second converter 211. For example, the second converter 211 may receive the three-phase stator current (iₐₛ, i_{bs}, i_{cs}) as inputs through a current sensor connected to the stator.

Thereafter, the current controller 203 may receive feedback on the converted d-axis current (i_{ds}) and q-axis current (i_{qs}) and may perform the current control so that the d-axis current (i_{ds}) and q-axis current (i_{qs}) can track the d-axis current reference (i_{ds}*) and the q-axis current reference (i_{qs}*).

More specifically, the current controller 203 may generate a d-axis voltage reference (V_{ds}*) and a q-axis voltage reference (V_{qs}*) to allow the d-axis current (i_{ds}) and the q-axis current (i_{qs}) to track the d-axis current reference (i_{ds}*) and the q-axis current reference (i_{qs}*) through the feedback of the converted d-axis current (i_{ds}) and q-axis current (i_{qs}). The generated d-axis voltage reference (V_{ds}*) and q-axis voltage reference (V_{qs}*) may be converted into three-phase voltage references (Vₐₙ*, V_{bn}*, V_{cn}*) through the first converter 204, and the inverter 300 may output an alternating current voltage to the stator of the induction motor 300 through pulse width modulation control based on the three-phase voltage references (Vₐₙ*, V_{bn}*, V_{cn}*) to drive the induction motor 300.

In an exemplary embodiment of the present disclosure, the slip angular velocity (ωₛₗ) may be determined by reflecting the variation of the rotor resistance (Rᵣ) according to the temperature changes, and accordingly the magnetic flux angle (θₑ) may be obtained to control the output of the induction motor 100, so that a relatively accurate magnetic flux angle (θₑ) can be obtained without separately equipping a magnetic sensor or the like for obtaining the magnetic flux angle (θₑ). In particular, a more accurate magnetic flux angle (θₑ) may be obtained by reflecting the variation of the rotor resistance (Rᵣ) according to the temperature of the induction motor 100 compared to using a fixed value as the value of the rotor resistance (Rᵣ), on the basis of which the output of the induction motor 100 may be controlled, thereby improving the precision of torque control.

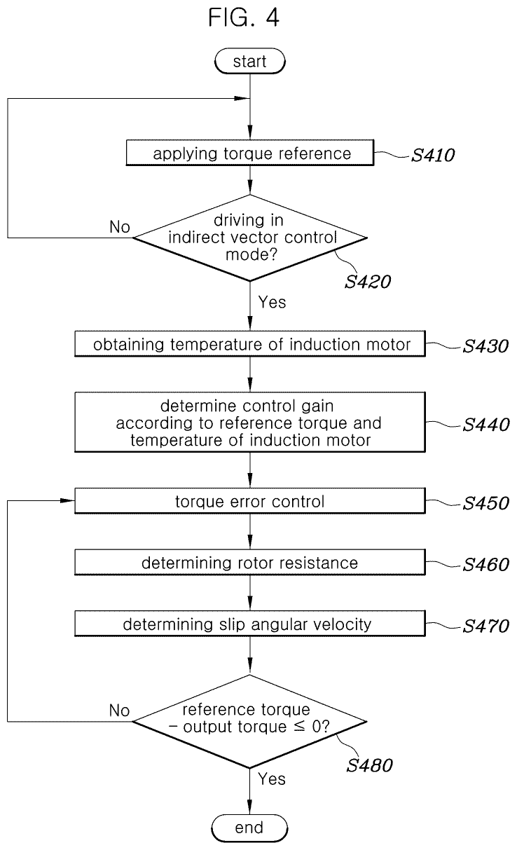

Hereinafter, a method of controlling the motor driving apparatus according to an exemplary embodiment of the present disclosure will be described with reference to FIG. 4.

FIG. 4 is a flowchart illustrating a method of controlling a motor driving apparatus according to an exemplary embodiment of the present disclosure.

Referring to FIG. 4, first, a torque reference to allow the induction motor 100 to output a reference torque may be applied (S410), and this torque reference may be determined by a required torque, and may be applied directly to the controller 200 or transmitted from an upper controller connected to the controller 200.

After the torque reference is applied, the controller 200 may determine whether the induction motor 100 is being driven in the indirect vector control mode, that is, whether the output of the induction motor 100 is being controlled by indirectly determining the magnetic flux angle through the slip angular velocity without directly detecting the magnetic flux angle of the rotating magnetic field through a magnetic sensor or the like (S420). When the induction motor 100 is not driven in the indirect vector control mode (No in S420), subsequent control may not be performed because there is no need to determine the slip angular velocity.

Meanwhile, when the induction motor 100 is driven in the indirect vector control mode (Yes in S420), the controller 200 may obtain the temperature of the induction motor 100 necessary for determining the slip angular velocity (S430), in which case the temperature of the induction motor 100 refers to the temperature of the stator coil and is obtained through a temperature sensor connected to the stator coil.

Then, the controller 200 may determine a control gain for the torque error control on the basis of the obtained temperature of the induction motor 100 and the reference torque (S440). For example, the controller 200 may determine the control gain corresponding to the current reference torque and the temperature of the induction motor 100 by referring to the table which stores the control gain corresponding to each of the reference torque and the temperature of the induction motor 100, wherein the control gain includes proportional gain and integral gain.

When the control gain is determined, the controller 200 may perform the torque error control to allow the output torque to track the reference torque on the basis of the reference torque of the induction motor 100, the output torque, and the control gain (S450), and may determine the value of the rotor resistance on the basis of the result of the torque error control (S460).

When the rotor resistance is determined, the controller 200 may determine the slip angular velocity on the basis of the rotor resistance (S470), and the torque error control may be repeated to re-determine the value of the rotor resistance when the error between the reference torque and the output torque exceeds a predetermined reference error (e.g., “0”) (No in S480). Thereafter, when the error between the reference torque and the output torque becomes less than or equal to a predetermined reference error (e.g., “0”) according to the torque error control (Yes in S480), the torque error control may be terminated and the value of the rotor resistance according to the result of the current torque error control may be maintained.

According to various exemplary embodiments of the present disclosure as described above, the estimation accuracy of the magnetic flux angle may be improved during indirect vector control, and accordingly, the precision of the torque control may be improved, by determining the slip angular velocity through the value of the rotor resistance that varies in real time.

In addition, as the precision of the torque control improves, reference torque tracking performance can be improved without a separate torque correction process.

Furthermore, various exemplary embodiments of the present disclosure may be implemented by adding logic to an existing controller, so the effects described above may be achieved without any increase in volume and cost due to a separate hardware configuration.

Although shown and described with respect to a specific exemplary embodiment of the present disclosure as described above, it will be obvious to those skilled in the art that the present disclosure may be variously improved and modified without departing from the technical ideas of the present disclosure as provided by the following patent claims.

1. A motor driving apparatus, the apparatus including:
an induction motor including a stator, and a rotor that rotates through a rotating magnetic field generated in the stator; and
a controller configured to determine a resistance of the rotor based on an error between a reference torque and an output torque of the induction motor and a temperature of the induction motor, and configured to control an output of the induction motor based on the determined resistance of the rotor.

2. The apparatus of claim 1, wherein the controller is configured to perform torque error control to allow the output torque to track the reference torque based on the temperature of the induction motor, and is configured to determine the resistance of the rotor based on a result of the torque error control.

3. The apparatus of claim 2, wherein the controller is configured to perform the torque error control repeatedly until the error between the reference torque and the output torque becomes less than or equal to a predetermined reference error, and wherein in response to the output torque being less than or equal to the predetermined reference error, the controller is configured to re-determine the resistance of the rotor.

4. The apparatus of claim 2, wherein the controller is configured to perform the torque error control based on a control gain predetermined to correspond to the temperature of the induction motor and the reference torque.

5. The apparatus of claim 4, wherein the control gain includes proportional gain and integral gain with respect to the error between the reference torque and the output torque.

6. The apparatus of claim 4, wherein the controller is configured to perform the torque error control by applying a control gain from a table comprising stored control gain values corresponding to each of the temperature of the induction motor and the reference torque.

7. The apparatus of claim 2, wherein the controller is configured to correct a result of the torque error control through an anti-windup with respect to the error between the reference torque and the output torque, and configured to determine the resistance of the rotor based on the corrected result of the torque error control.

8. The apparatus of claim 1, wherein the temperature of the induction motor is a coil temperature of the stator.

9. The apparatus of claim 1, wherein the controller is configured to determine slip angular velocity of the induction motor based on the resistance of the rotor, and is configured to control the output of the induction motor based on the determined slip angular velocity.

10. The apparatus of claim 9, further including:
an inverter configured to drive the induction motor,
wherein the controller is configured to convert a current of the stator into a synchronous reference frame based on the slip angular velocity, and is configured to control the output of the induction motor by controlling the inverter through pulse width modulation (PWM) control based on the converted current.

11. A method for controlling a motor driving apparatus, the method including:
determining a resistance of a rotor by a controller based on an error between a reference torque and an output torque of an induction motor including a stator and the rotor that rotates through a rotating magnetic field generated in the stator and a temperature of the induction motor; and
controlling an output of the induction motor by the controller based on the determined resistance of the rotor.

12. The method of claim 11, wherein the determining the resistance of the rotor includes performing torque error control to allow the output torque to track the reference torque based on the temperature of the induction motor by the controller, and determining the resistance of the rotor based on a result of the torque error control.

13. The method of claim 12, wherein the determining the resistance of the rotor includes performing the torque error control repeatedly by the controller until the error between the reference torque and the output torque becomes less than or equal to a predetermined reference error, and wherein in response to the output torque being less than or equal to the predetermined reference error, the resistance of the rotor is re-determined.

14. The method of claim 12, wherein the determining the resistance of the rotor includes performing the torque error control by the controller based on a control gain predetermined to correspond to the temperature of the induction motor and the reference torque.

15. The method of claim 14, wherein the control gain includes proportional gain and integral gain with respect to the error between the reference torque and the output torque.

16. The method of claim 14, wherein the determining the resistance of the rotor includes performing the torque error control by the controller by applying a control gain from a table which stores the control gain corresponding to each of the temperature of the induction motor and the reference torque.

17. The method of claim 12, wherein the determining the resistance of the rotor includes correcting a result of the torque error control by the controller through an anti-windup with respect to the error between the reference torque and the output torque, and determining the resistance of the rotor based on the corrected result of the torque error control.

18. The method of claim 11, wherein the temperature of the induction motor is a coil temperature of the stator.

19. The method of claim 11, wherein the controlling the output of the induction motor includes determining slip angular velocity of the induction motor by the controller based on the resistance of the rotor, and controlling the output of the induction motor based on the determined slip angular velocity.

20. The method of claim 19, wherein the controlling the output of the induction motor includes converting a current of the stator into a synchronous reference frame by the controller based on the slip angular velocity, and controlling the output of the induction motor by controlling an inverter for driving the induction motor through pulse width modulation control based on the converted current.
